(19) United States
(12) Patent Application Publication
(10) Pub. No.: US 2008/0216400 A1
(43) Pub. Date: Sep. 11, 2008

(54) Plant culture container structure

(76) Inventor: Chiang-Kuei Feng, Kaohsiung County (TW)

Correspondence Address: Joe McKinney Muncy, PO Box 1364, Fairfax, VA, 22038-1364, US

(21) Appl. No.: 11/714,810

(22) Filed: Mar. 7, 2007

(51) Int. Cl. A01G 9/02

(52) U.S. Cl. 47/32.7

(57) ABSTRACT

The present invention discloses an improved plant culture container structure that includes a container having a containing groove; a plurality of vertical root guiding lines disposed with a specific vertical distance from each other and formed on an internal wall of said container; and one or more horizontal root guiding lines disposed around the internal wall of the container and coupled to the internal wall of said container, for restricting the root of the plant to grow downward to strengthen and secure the plant into the soil.

### FIELD OF THE INVENTION

The present invention relates to an improved plant culture container, and more particularly to a container capable of guiding the root of a plant to grow downward and securing the plant into the soil.

### BACKGROUND OF THE INVENTION

Referring to FIG. 1 for a conventional plant culture container 1, the container 1 comprises a containing groove 10, one or more rounds of horizontal root guiding lines 11 disposed transversally from an upper edge to a lower edge of an internal wall of the container 1, and a plurality of vertical root guide lines disposed on the internal wall of the container 1 and perpendicular to the horizontal root guiding lines 12 without being connected to the horizontal root guiding lines 12.

When a plant 2 is cultured in the container, roots 20 of the plant 2 can be grown downward along the vertical root guiding lines 12, but the vertical root guiding lines 12 and the horizontal root guiding lines 11 on the internal wall of the container 1 are not connected with each other, so that after the root 20 of the plant 2 fills up the internal wall of the container 1 and the root 20 of the plant 2 is in contact with one or more rounds of horizontal root guiding lines 11 on the internal wall of the container 1, the root 20 will continue to grow several rounds along the horizontal root guiding line 11 on the internal wall of the container 1 and climb upward, such that the root 20 of the plant 2 will be wound around an upper edge of the container 1 (as shown in FIG. 2).

If the root 20 of the plant 2 has climbed one or more rounds of horizontal root guiding lines 11, the root 20 will be unable to continue to grow along the horizontal root guiding lines 11, but the root 20 will grow out from the container 1. Now, the root 20 of the plant 2 is exposed from the containing groove 10, and thus the plant will not be able to absorb sufficient nutrients, and the growth of the plant 2 will be affected adversely due to the insufficient absorption of nutrients from the roots 20.

When the root 20 of the plant 2 is wound around the upper edge of the containing groove 10 of the container 1 and exposed to the outside, the root 20 of the plant 2 grows upward and the growth of the plant 2 is affected, and thus it is very difficult to secure the plant into the soil

### SUMMARY OF THE INVENTION

Therefore, it is a primary objective of the present invention to provide an improved plant culture container structure for restricting the root of a plant to grow downward and guiding the root to grow downward and secure the plant into the soil.

To achieve the foregoing objective, the present invention provides an improved plant culture container structure that includes a container having a containing groove; a plurality of vertical root guiding lines disposed with a specific vertical distance from each other and formed on an internal wall of said container; and one or more horizontal root guiding lines disposed around the internal wall of the container and coupled to the internal of said container, for restricting the root of the plant to grow downward and enhance and secure the plant into the soil.

With the improved plant culture container structure, the present invention can achieve the following effects:

1. The growing direction of the roots of a plant is limited. With the horizontal root guiding lines and vertical root guiding lines disposed alternately on the internal wall of the containing groove of the container, so that when the plant grows, the root is wound along the horizontal root guiding lines and vertical root guiding lines and grown downward in the container, so that the root can be grown downward, and the plant can be secured into the soil.

2. The root of the plant is secured much better into the soil. With the container of the present invention, the root of the plant grows along the horizontal root guiding lines and vertical root guiding lines, so that the root of the plant root can be secured much better into the soil.

### BRIEF DESCRIPTION OF THE DRAWINGS

FIG. 1 is a perspective view of a conventional plant culture container;

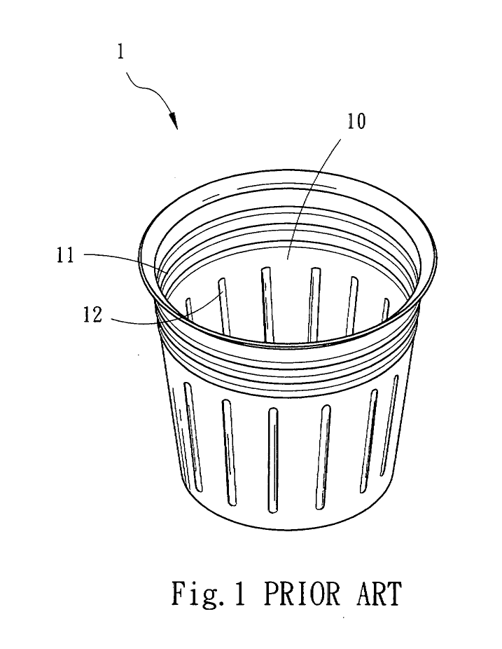

FIG. 2 is a schematic view of culturing a plant in a conventional plant culture container;

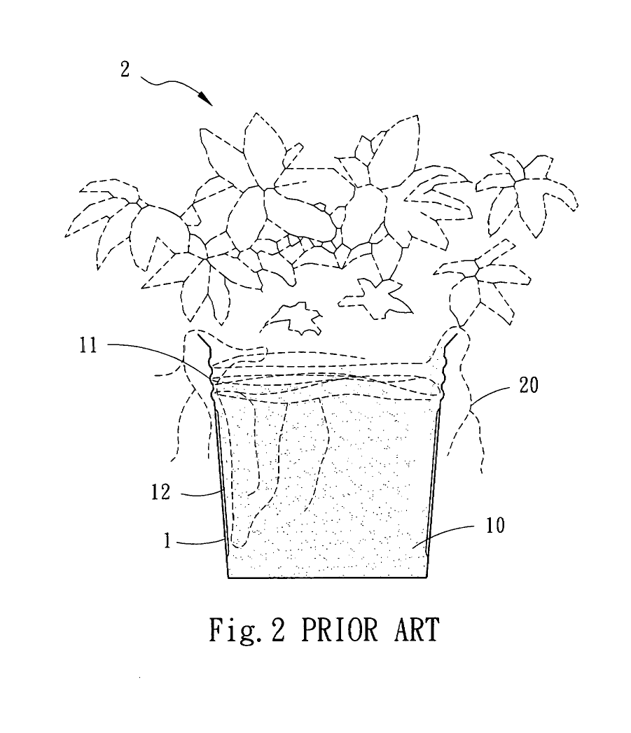

FIG. 3 is a perspective view of a plant culture container of the present invention;

FIG. 4 is a schematic view of culturing a plant in a plant culture container of the present invention;

FIG. 5 is a perspective view of culturing a plant in a plant culture container of the present invention;

FIG. 6 is a perspective view of a first preferred embodiment of the present invention;

FIG. 7 is another perspective view of a first preferred embodiment of the present invention;

FIG. 8 is a further perspective view of a first preferred embodiment of the present invention;

FIG. 9 is a perspective view of a second preferred embodiment of the present invention;

FIG. 10 is a perspective view of a third preferred embodiment of the present invention;

FIG. 11 is another perspective view of a third preferred embodiment of the present invention; and

FIG. 12 is a further perspective view of a third preferred embodiment of the present invention.

### DETAILED DESCRIPTION OF THE PREFERRED EMBODIMENTS

The present invention will now be described in more detail hereinafter with reference to the accompanying drawings that show various embodiments of the invention.

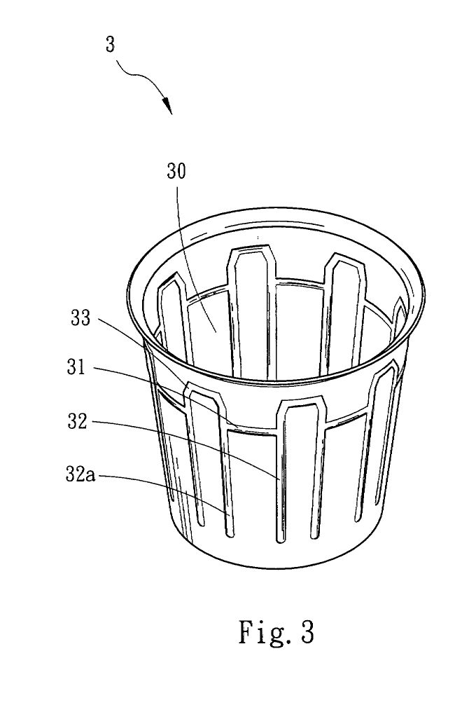

Referring to FIG. 3 for the structure of a plant culture container 3, the structure comprises a container 3 having a containing groove 30, a plurality of horizontal root guiding lines 31 disposed with a specific vertical distance with each other and formed at an internal wall of the container 3, wherein one or more vertical root guiding lines 32, 32a disposed around the internal wall of the container 3 and coupled to the horizontal root guiding lines 31.

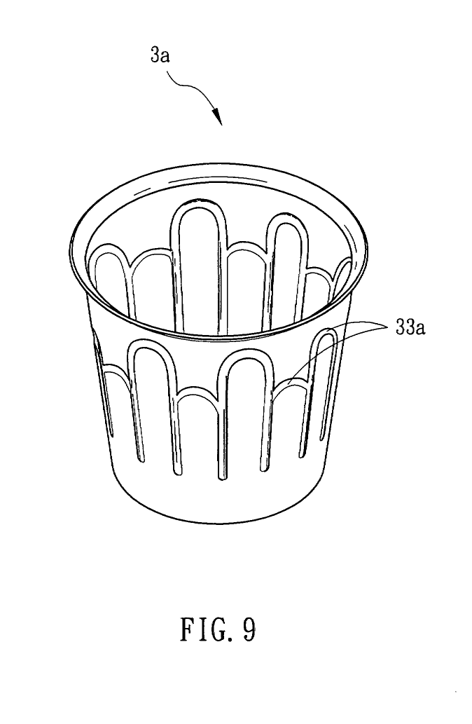

In the structural design of a preferred embodiment of the present invention, an oblique line 33 is formed at a connecting end of the vertical root guiding lines 32, 32a and the horizontal root guiding lines 31 as shown in FIG. 3. In the structural design of another preferred embodiment of the present invention, an arc 33a or a curved line or a geometric shape is formed at a connecting end of the vertical root guiding lines 32, 32a and the horizontal root guiding lines 31 as shown in FIG. 9.

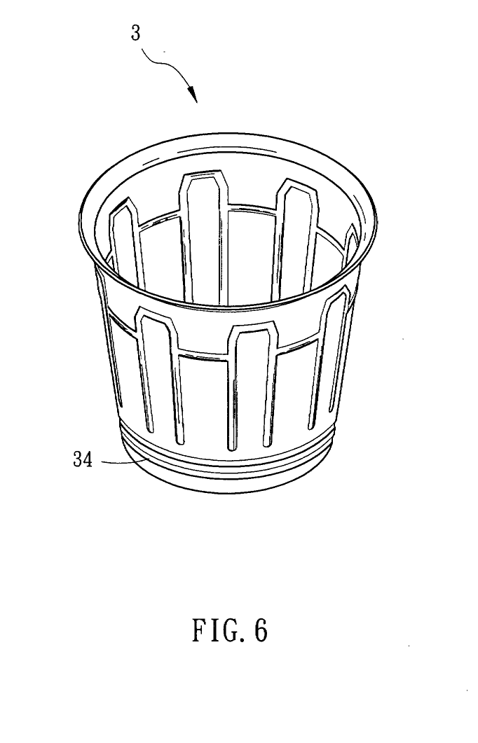

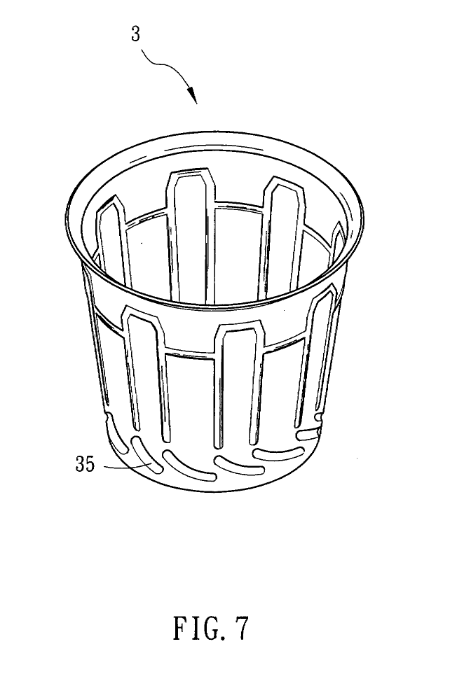

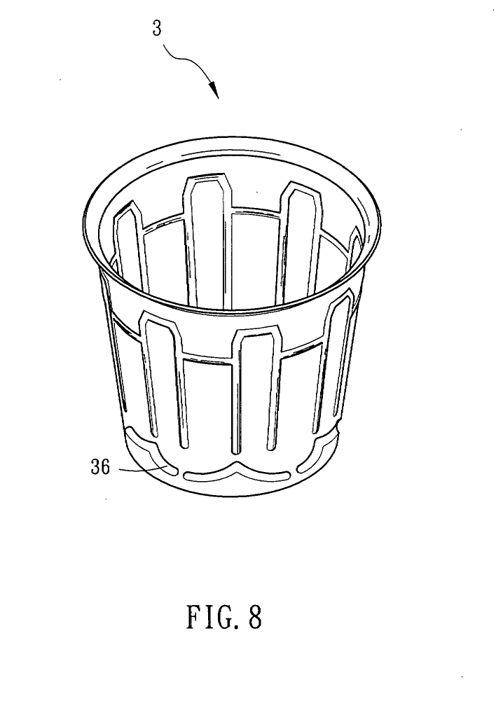

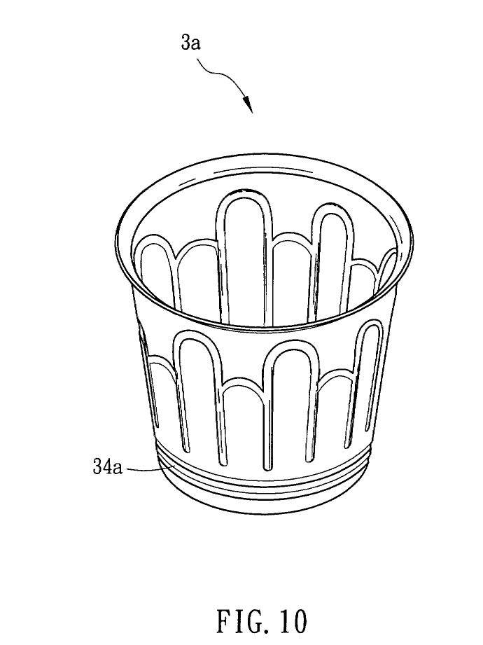

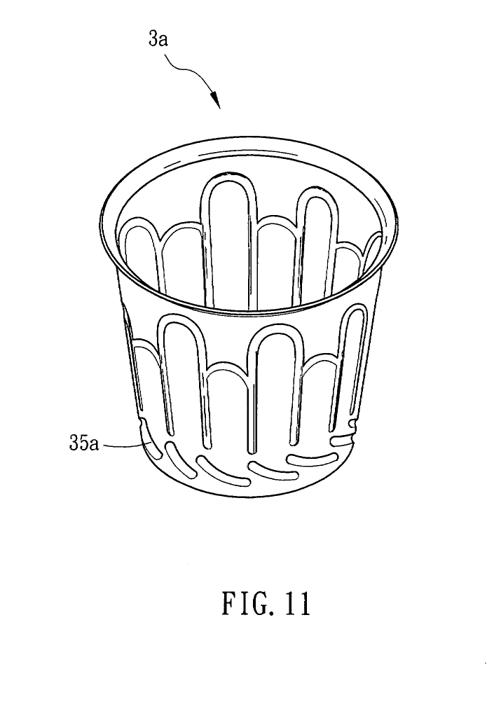

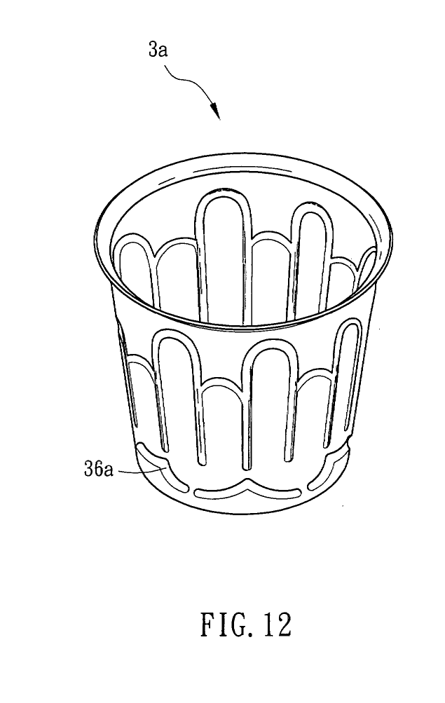

In the structural design of the present invention, the horizontal root guiding lines 31 can be disposed on a lower edge of an internal wall of the container 3, 3a as shown in FIGS. 6 and 10 to form serrated connecting root guiding lines 34, 34a, and the root guiding lines 34, 34a can be discontinued root guiding lines 35, 35a as illustrated in the structural design of FIGS. 7 and 11, or discontinued streamlined or geometric root guiding lines 36, 36a as illustrated in the structural design of FIGS. 8 and 12.

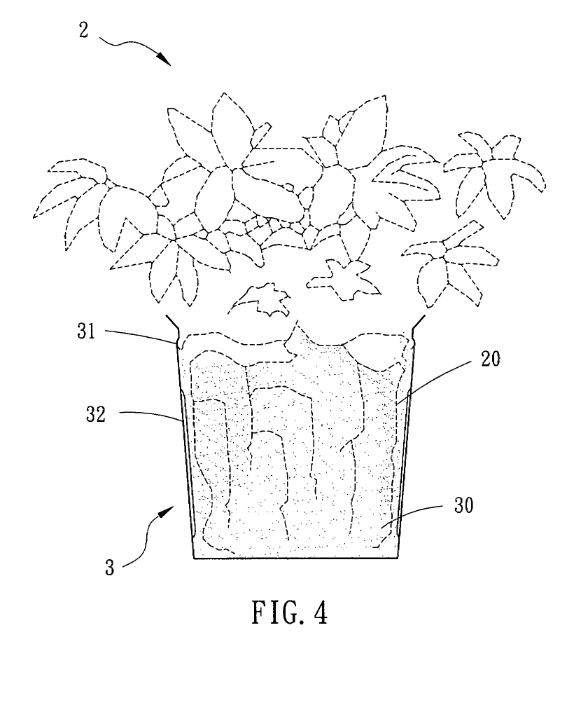

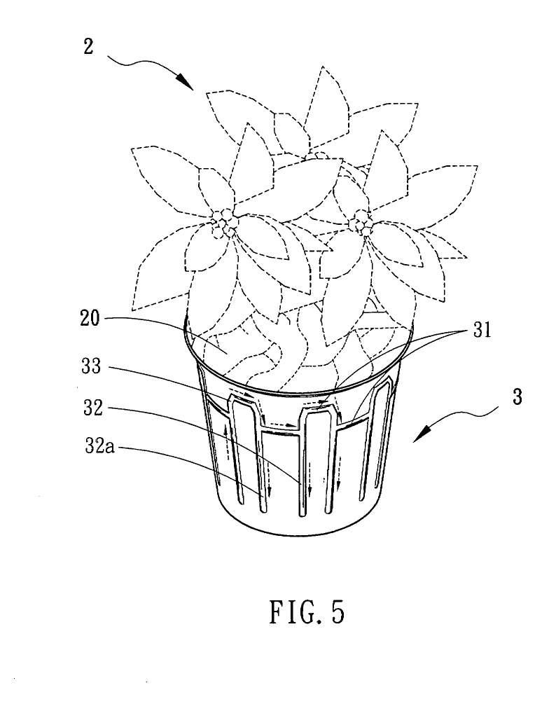

Referring to FIGS. 4 and 5, the container 3 has horizontal root guiding lines 31 and vertical root guiding lines 32 disposed on an internal wall of the container 3, for restricting the plant 2 in the container 3 to grow downward, so that when the plant 2 is cultured in the containing groove 30 of the container 3, the root 20 of the plant 2 will grow along the horizontal root guiding lines 31 coupled to the vertical root guiding lines 32 for guiding the root 20 of the plant 2 to grow downward repeatedly and distributed in the containing groove 30, so as to enhance and secure the root 20 of the plant 2 much better into the soil.

If the root 20 of the plant 2 fills up the containing groove 30 of the container 3, the root 20 will climb upward along the vertical root guiding lines 32 on the internal wall of the container 3. If the root 20 of the plant 2 is in contact with the horizontal root guiding lines 31, the horizontal root guiding lines 31 will guide the root 20 to grow downward along another vertical root guiding line 32a and within the internal wall of the container 3.

If the root 20 of the plant 2 is in contact with another vertical root guiding line 32a coupled to the horizontal root guiding line 31, the root 20 will grow along another vertical root guiding line 32a, and then to the bottom of the containing groove 30 of the container 3.

Therefore, the root 20 of the plant 2 is guided along the horizontal root guiding line 31 and the vertical root guiding line 32, so that the root 20 can be controlled to grow downward within the containing groove 30 of the container 3, and the root 20 of the plant 2 is grown downward and secured into the soil.

Since the root 20 of the plant 2 is guided by the horizontal root guiding line 31 and the vertical root guiding lines 32, 32a, the root 20 of the plant 2 can be grown downward more regularly within the containing groove 30 of the container 3 to achieve the effects of preventing the root 20 from being exposed to the outside and guiding the root 20 of the plant 2 to grow downward and secure the plant 2 into the soil.

What is claimed is:

1. An improved plant culture container structure; comprising:
a container, having a containing groove;
a plurality of vertical root guiding lines, formed on an internal wall of said container; and
a plurality of horizontal root guiding lines, coupled to the internal of said container.

2. The improved plant culture container structure of claim 1, wherein said vertical root guiding line comes with the quantity of one or more.

3. The improved plant culture container structure of claim 1, wherein said vertical root guiding line and said horizontal root guiding line constitute an oblique line disposed at a connecting end of said vertical root guiding line and said horizontal root guiding line.

4. The improved plant culture container structure of claim 1, wherein said vertical root guiding line and said horizontal root guiding line constitute an arc disposed at a connecting end of said vertical root guiding line and said horizontal root guiding line.

5. The improved plant culture container structure of claim 1, wherein said horizontal root guiding lines are disposed at a lower edge of an internal wall of said container to define a plurality of serrated connecting root guiding lines.

6. The improved plant culture container structure of claim 5, wherein said container forms a plurality of discontinuous root guiding lines disposed at a lower edge of an internal wall of said container.

7. The improved plant culture container structure of claim 5, wherein said container forms a plurality of geometric root guiding lines disposed at a lower edge of an internal wall of said container.
